(19) United States
(12) Patent Application Publication
(10) Pub. No.: US 2026/0241599 A1
(43) Pub. Date: Aug. 20, 2026

(54) METHOD FOR AUTOMATIC CUTTING A SHEET MATERIAL AND RELATIVE SYSTEM FOR AUTOMATIC CUTTING

(71) Applicant: MORGAN TECNICA S.P.A., ADRO (IT)

(72) Inventor: Fabrizio GIACHETTI, ADRO (IT)

(21) Appl. No.: 19/470,923

(22) PCT Filed: Mar. 26, 2024
(86) PCT No.: PCT/IT2024/050063

§ 371 Date: Sep. 30, 2025

(30) Foreign Application Priority Data
Mar. 31, 2023 (IT) 102023000006279

(51) Int. Cl. B26D 5/00; G05B 19/4097

(52) U.S. Cl. CPC B26D 5/005; G05B 19/4097; B26D 2005/002; G05B 2219/45044; G05B 2219/45234

(57) ABSTRACT

Method and system (1) for automatically cutting of sheet material, the system comprising an automatic cutting machine (2) of sheet material, and a processing unit (7) having a memory unit (8), where the memory unit (8) contains a finite set of reference shapes (90), where the method comprises providing a set of current shapes (91) loaded by the processing unit (7), performing a comparison between each current shape with the reference shapes, determining at least one cutting parameter for each current shape as a function of the comparison, cutting each current shape with the at least one cutting parameter determined.

### TECHNICAL FIELD OF THE INVENTION

The present invention relates to a method for automatic cutting a sheet material, preferably flexible (e.g. woven fabric, knitted fabric, non-woven fabric, natural leather, synthetic leather, polymeric sheets, etc.), and a relative system for automatic cutting of sheet material comprising at least one automatic cutting machine.

### STATE OF THE ART

It is known cutting sheet materials, for example in single sheet or arranged in stacks of overlapping layers (also called “plies”), by automatic cutting machines for realizing pieces of material cut according to cutting shapes having a given geometric shape and dimensions. Such pieces are typically used to make garments.

Typically, the automatic cutting machines proceed to cut the aforementioned pieces according to a pattern, also called “placement”, which establishes, typically according to algorithms designed to minimize the waste of sheet material, the reciprocal arrangement of the cutting shapes within the spatial extension of the sheet.

### SUMMARY OF THE INVENTION

With the expression “cutting parameter” or analogously “process parameter” it is meant the value of a physical quantity (e.g. oscillation speed of the cutting blade) in function of which the automatic cutting of at least one cutting shape from a sheet material is performed, and/or a given process functionality (e.g. active cooling of the cutting blade) to be activated or not during the automatic cutting of the shape.

In the context of the automatic cutting of sheet material through the use of an automatic cutting machine, the Applicant has observed that in determinate automatic cutting conditions (e.g. for determinate values of the process/cutting parameters, as the horizontal movement speed, and/or the oscillation speed, of the blade), some pieces cut according to one or more cutting shapes of the placement may result, entirely or partially (i.e. at only one or more portions of the cutting shape), defective (e.g. with frayed and/or torn edges, variations compared to the nominal shape, etc.), with following waste of the pieces. Such shapes may result difficult to cut due to a set of factors (e.g. geometric shape of the shape or portion of the shape, dimensions of the shape, aspect ratio, type of sheet material to be cut, etc.), possibly interdependent with each other.

For overcoming such situation, it is possible to configure the process parameters so that such difficult shapes are cut without defects.

However, the Applicant has observed that, on one side, a configuration of the process parameters identical for all the cutting shapes and calibrated on the aforementioned difficult shapes can involve a scarce production yield, incompatible with the desired industrial regimes.

The Applicant, however, considers advantageous to configure the process parameters in a differentiated way within the placement, dynamically adapting them to the specific shape to be cut. In this way, the difficult shapes can be cut with desired quality, while maintaining high the cutting productivity of the non-difficult shapes (and therefore the overall yield).

In realizing the above, the Applicant has also realized being not very satisfactory the use of prediction algorithms aimed at identifying in advance which cutting shapes (or portions of the shape) of the placement could actually be defective when cut. In fact, the practical implementation of such prediction algorithms can result complex, for example because it typically involves an intensive preliminary analysis work of the numerous factors that could generate the aforementioned cutting defects, factors which are generally hardly predictable in a complete way and/or or with desired precision. Furthermore, the use of such prediction algorithms can be onerous in terms of computational effort.

The Applicant has therefore faced the problem of performing the automatic cutting of sheet material in an efficient way and with desired quality for each cutting shape of the placement, even in case of a placement that comprises heterogeneous shapes regarding the cutting difficulty.

According to the Applicant, the aforementioned problem is solved by a method for automatic cutting a sheet material, and by a system for automatic cutting a sheet material, according to the attached claims and/or having one or more of the following features.

According to an aspect, the invention relates to a method for automatic cutting a sheet material, the method comprising:
providing a finite set of reference shapes;
providing a set of current shapes;
performing a comparison between each current shape with said reference shapes;
determining at least one cutting parameter for each current shape as a function of said comparison;
cutting each current shape with said at least one cutting parameter determined.

According to another aspect, the present invention relates to a system for automatic cutting a sheet material comprising (at least) an automatic cutting machine of sheet material, and a processing unit having a memory unit.

Preferably said processing unit is connected to said machine (for controlling said machine).

Preferably said memory unit contains (digital information representative of) a finite set of reference shapes.

Said processing unit is programmed and configured for:
loading (further digital information representative of) a set of current shapes;
performing a comparison between each current shape with said reference shapes of said finite set;
determining at least one cutting parameter for each current shape as a function of said comparison;
commanding a cutting device of said cutting machine for cutting each current shape with said at least one cutting parameter determined.

According to a further aspect, the invention relates to a computer program which, when executed by a processing unit, performs the method according to the present invention.

According to another aspect, the invention relates to a computer-readable medium containing a computer program which, when executed by a processing unit, performs the method according to the present invention.

For the purposes of the present invention, with the expression “shape” it is meant the geometric shape of a cutting line, which can be a cutting line with closed profile (which defines a corresponding piece of sheet material to be cut), possibly comprising further closed and/or open cutting lines inscribed in said closed profile, or even an open cutting line (e.g. corresponding only to a portion of the cutting line of the piece to be cut).

By “determining at least one cutting parameter” it is meant adjusting a respective value of at least one physical quantity as a function of which the automatic cutting of each current shape is performed and/or determining the activation (or not) of at least one respective process functionality contextually to the cutting of each current shape. According to the Applicant, the finite set of reference shapes contained in the memory unit (e.g. local and/or remote), for example determined on the basis of a previous cutting experience, allows to realize in simple, rapid and efficient way a database (e.g. a “black list”) on which performing the subsequent comparison of the current shapes, without the need to resort to prediction algorithms of the shapes that are difficult to cut, with consequent elimination of the corresponding problems described above. The Applicant observes that the use of such prediction algorithms implies a non-finite set of reference shapes (e.g. comprising infinite possible reference shapes that satisfy the identification criteria of the algorithm).

The comparison between the current shapes and the reference shapes allows to identify, in simple and accurate way, possible current shapes (or portions thereof) equal or similar to reference shapes (or their portions), thus allowing to identify the eventual difficult shapes present in the placement. On the contrary, the use of prediction algorithms only results complex, as it needs preliminarily defining mathematical rules and/or laws of prevision of the presumably difficult shapes, and typically subject to a greater risk of error, as the aforementioned rules and/or prediction laws need to be validated both a priori and a posteriori.

The determination of at least one cutting parameter as a function of the comparison allows to dynamically adjust the cutting in dedicated way for each current shape, so that the entire placement is cut with high productivity (avoiding, for example, that non-difficult shapes are cut with the cutting parameters suitable for difficult shapes, typically more penalizing in terms of production yield).

The present invention in one or more of the aforementioned aspects may present one or more of the following preferred features.

Preferably said processing unit is programmed and configured for performing and/or allowing to perform (e.g. by an operator) one or more of, more preferably all, the steps of said method according to the present invention.

Preferably providing said finite set of reference shapes is performed in a digital (i.e. computer-based) environment. Preferably providing said finite set of reference shapes comprises (more preferably consists of) providing digital information representative of said finite set of reference shapes.

Preferably providing said set of current shapes is performed in said digital environment. Preferably providing said set of current shapes comprises (more preferably consists of) providing further digital information representative of said set of current shapes.

In other terms, the sets of shapes, respectively of reference and current, are digitally realized. In this way the respective management is simplified.

Preferably said set of current shapes comprises shapes to be cut from said sheet material.

Preferably said memory unit of said system for automatic cutting realizes said digital environment.

Preferably providing said finished set of reference shapes comprises realizing a database containing said digital information representative of each reference shape. Preferably said memory unit contains said database.

For example, said memory unit can be a physical memory, allocated onto the cutting machine, or a remote memory in communication with the processing unit by a telecommunications network, or even a hybrid solution that provides both previous options.

Preferably said reference shapes are predetermined.

Preferably providing said finite set of reference shapes (more preferably realizing said database) is performed on empirical basis as a function of an outcome of a set of shape cutting operations. Preferably, subsequently to a cutting operation of a determinate shape, it is provided inserting said determinate shape into said finite set of reference shapes (loading said determinate shape into said database) on condition that said cutting operation has generated a defective cut piece. In other words, the reference shapes represent shapes which, for determinate cutting parameters, have previously generated defective cut pieces and which, precisely because of this empirical result obtained, have been identified as reference shapes (and therefore loaded into the database in the form of respective digital information). In this way the determination of the finished set is simple and direct, with the evidence that the reference shape is actually difficult to cut (since this evidence has been concretely demonstrated by a previous real cutting operation). For example, the computer program comprises a user interface suitably configured to allow an operator to determine the finite set of reference shapes (e.g. by the insertion of the desired shapes into the database).

Preferably said comparison between each current shape with said reference shapes comprises (more preferably coincides with) a respective geometric comparison between each current shape with each of said reference shapes. In other words, the geometric shape of each current shape is compared with the respective geometric shape of each reference shape.

Preferably determining said at least one cutting parameter is performed as a function of an outcome of said respective geometric comparison. For example, as a function of the outcome of the geometric comparison (i.e. whether a given current shape has been considered difficult to cut or not), the value of a given physical quantity as a function of which the automatic cutting of the given current shape is to be performed, and/or the activation or not of a given process functionality during such cutting of the given current shape is determined.

Preferably loading said set of current shapes comprises loading said set of current shapes into said memory unit (preferably from a digital file generated by an appropriate software, e.g. computer-assisted drawing software).

Preferably said automatic cutting machine comprises a cutting device (e.g. a cutting blade).

In one embodiment, said method further comprises:
providing (in said digital environment) one or more further sets of respective current shapes (to be cut from said sheet material);
performing a (respective) (geometric) comparison between each respective current shape of said one or more further sets with said reference shapes of said finished set;
determining at least one respective cutting parameter for each respective current shape as a function (of an outcome) of said (respective) (geometric) comparison;
cutting (from said sheet material) each respective current shape with said at least one respective cutting parameter determined.

Preferably said system for cutting comprises one or more further cutting machines.

Preferably said system for cutting comprises a central electronic unit (e.g. one or more servers), more preferably comprising said memory unit.

Preferably said processing unit comprises a respective processing sub-unit for each machine of said system (i.e. said machine and each further machine). Functionally, each respective processing sub-unit may preferably behave in equivalent way to the processing unit.

Preferably each processing sub-unit is in data communication with said central electronic unit (e.g. by a telecommunications network) to consult said finite set of reference shapes (e.g. in the form of the respective digital information). In this way each machine is connected to the servers.

Preferably said processing unit is programmed and configured to:
for each further cutting machine, loading (in said memory unit) a respective further set of current shapes (to be cut from said sheet material);
performing a (respective) (geometric) comparison between each current shape of each further set with said reference shapes;
determining at least one respective cutting parameter for each current shape of each further set as a function of (an outcome of) said (respective) (geometric) comparison;
commanding a respective cutting device (e.g. a respective cutting blade) of each further cutting machine for cutting (from said sheet material) each current shape of the respective further set with said at least one respective cutting parameter determined.

In this way, a network of end users which share the finite set of reference shapes is realized, to the advantage of the diffusion of the same set of reference information and of the realization of a desired uniformity in the quality of the cut, regardless of the geographical location of the user (e.g. of the respective cutting machine).

Preferably said method comprises providing a set of further current shapes, more preferably subsequently to said cutting each current shape of said set (and/or of a further set). Preferably said method comprises performing, for each further current shape, all the steps performed for each current shape of said set (and/or of a further set).

Preferably providing said finite set of reference shapes comprises updating said finite set of reference shapes subsequently to said cutting each current shape of said set (and preferably of each further set), preferably as a function of an outcome of a cutting operation of said current shapes, more preferably before performing a comparison between each further current shape with said reference shapes.

Preferably said processing unit is programmed and configured for having write access to said memory unit for updating said finite set of reference shapes (more preferably for updating said database by loading new reference shapes). In this way the finite set of reference shapes can be updated on the basis pf the real cutting outcome of the current shapes. In this way, a dynamic adjustment of the finished set of reference shapes is obtained in simple way, preferably before the cutting of a new set of further current shapes, eventually benefiting, from each user, also from the cutting experiences performed by the remaining users, increasing in this way the casuistry of reference shapes.

Preferably performing said (respective) (geometric) comparison comprises evaluating a geometric similarity between said each current shape with said reference shapes. Preferably it is provided applying one or more geometric similarity criteria (e.g. congruence of the corresponding angles and proportionality between the corresponding sides, eventually setting a tolerance threshold). In this way the comparison is simple and quick, for example from a computational point of view. Furthermore, the comparison is independent of the orientation in the plane of both of the current and of reference shapes.

Preferably performing said (respective) (geometric) comparison comprises processing (preferably by said processing unit) said digital information and said further digital information for evaluating, for each current shape, a geometric similarity with at least one of said reference shapes. Preferably said geometric similarity comprises both the case of geometric similarity and the case of geometric identity between the shapes.

Preferably determining said at least one cutting parameter comprises adjusting a respective value of at least one of the following physical quantities and/or determining an activation of at least one of the following process functionalities:
speed of horizontal movement of said (respective) cutting device,
speed of vertical oscillation of the (respective) cutting device,
path in a (cutting) plane of the (respective) cutting device,
direction of motion in the (cutting) plane of the (respective) cutting device,
suction force of a suction system of said machine (which holds the textile material to be cut adhering to a cutting surface),
possibility of vertical lifting of the (respective) cutting device when at one or more vertices of said current shape,
active cooling (using suitable devices) of the (respective) cutting device.

Preferably adjusting said respective value of said at least one physical quantity comprises:
setting said respective value to a first value on condition that said geometric similarity is absent;
setting said respective value to a second value on condition that said geometric similarity is present, wherein said first value is different from said second value.

Preferably said respective value can alternatively assume only said first and second values. In this way the adjustment is simplified.

With reference to the cutting parameter, the terms horizontal and vertical typically refer to a horizontal cutting plane of the cutting machine. The Applicant has realized the aforementioned physical quantities/process functionalities represent cutting parameters advantageous to appropriately determine for improving the cutting of difficult shapes, also, eventually, realizing respective combinations.

In one embodiment said method comprises associating to each reference shape one or more reference sheet materials. Preferably said memory unit contains (respective digital information representative of) one or more reference sheet materials associated to each reference shape. Reference sheet materials preferably represent materials for which the cutting of the associated reference shapes has revealed particularly difficult.

Preferably determining said at least one cutting parameter is also performed as a function of a comparison between a current sheet material (e.g. from which the current shapes are to be cut) and said one or more reference sheet materials. In this way the cut also takes into account the type of material to be cut, to the advantage of cutting accuracy and/or efficiency.

### BRIEF DESCRIPTION OF THE DRAWINGS

FIG. 1 schematically shows a system for cutting according to a first embodiment of the present invention;

FIG. 2 schematically shows a system for cutting according to a second embodiment of the present invention;

FIG. 3 schematically shows some steps of a method according to the present invention.

### DETAILED DESCRIPTION OF SOME EMBODIMENTS OF THE INVENTION

The features and the advantages of the present invention will be further clarified by the following detailed description of some embodiments of the present invention, presented by way of example and not by way of limitation, with reference to the attached figures.

In the figures, with the number 1 it is globally indicated a system for automatic cutting a sheet material, for example fabric.

Exemplarily the system 1 comprises an automatic cutting machine 2 for cutting sheet material (shown in a purely schematic way).

Exemplarily the machine 2 comprises a cutting plane 3 (only partially shown), on which a pile of sheets of sheet material 4 to be cut is arranged, and a suction system (not shown), for example comprising a fan, and structured for generating a depression below the cutting plane to keep the pile in adhesion against the cutting plane.

Exemplarily the machine 2 also comprises a cutting head 5 (only schematically shown), above the cutting plane 3 and comprising a cutting device (e.g. a blade, preferably vertically oscillating, not shown).

Exemplarily the cutting head 5 is movably fixed to a movement bridge 6 movable along a first axis (not shown) parallel to a main development direction of the cutting plane. Typically, the cutting head is movable with respect to the bridge along a second axis (not shown) substantially perpendicular to the first axis and parallel to the cutting plane.

Exemplarily the system 1 also comprises a processing unit 7 (only schematically shown) having a memory unit 8.

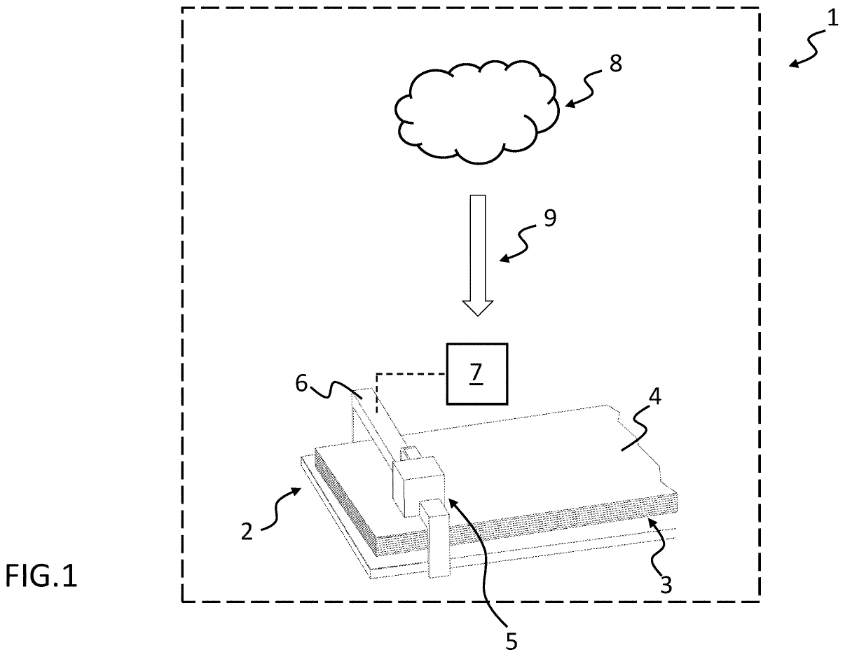

Exemplarily the processing unit 7 is connected to the machine 2 for commanding the machine 2. For example, the processing unit 7 can be physically installed on board the machine 2 and/or remotely arranged and in data connection with the machine 2. Exemplarily the memory unit 8 is represented as a remote unit (for example comprising one or more cloud servers) connected to the processing unit 7 by a telecommunications network 9 (only schematically shown by the arrow in FIG. 1).

In one not shown embodiment, the memory unit can be entirely or partially housed locally in machine.

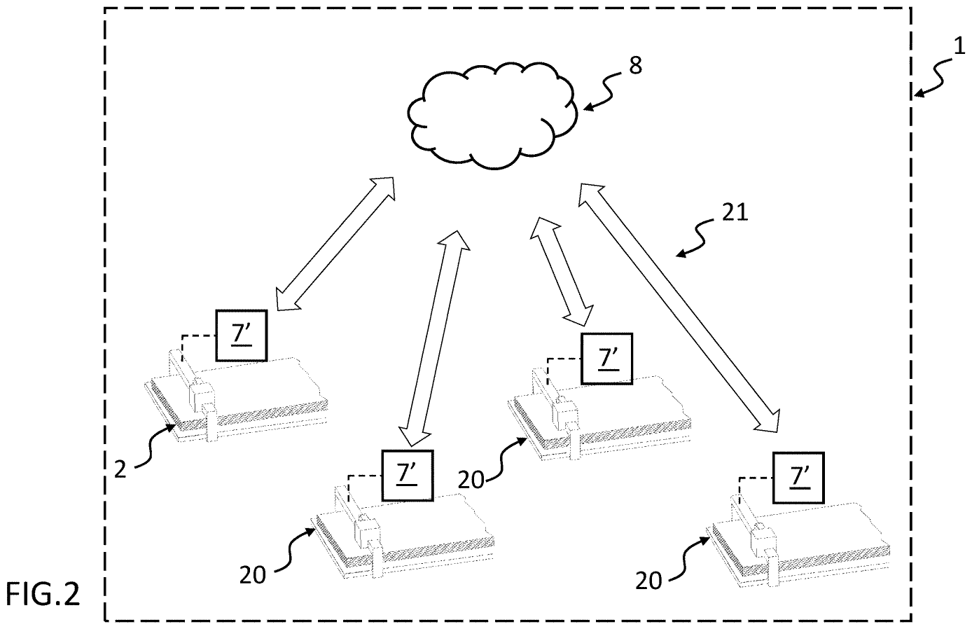

In one embodiment, as shown for example in FIG. 2, the system 1 can comprise any number of further cutting machines. For example, in FIG. 2, the system comprises three further cutting machines 20 (schematically shown in symbolic way identical to machine 2). Exemplarily, each cutting machine ideally represents a respective geographically dislocated user.

In such embodiment, the processing unit 7 exemplarily comprises a processing sub-unit 7′ for each machine 2, 20 of the system 1. Each processing sub-unit can for example be a physical unit installed on the respective machine and/or a remote unit connected to the respective machine by a telecommunications network (e.g. internet network). For the purposes of the method of the present invention (described below in detail), each processing sub-unit 7′ can be functionally equivalent to the processing unit 7.

In the embodiment of FIG. 2, exemplarily the system for cutting 1 also comprises a central electronic unit comprising the memory unit 8, for example comprising one or more cloud servers. Exemplarily, each processing sub-unit 7′ is in data communication with the central electronic unit by a telecommunications network 21 (only schematically shown by the double arrows).

In use, the system for cutting 1 allows to perform a method for automatic cutting of sheet material.

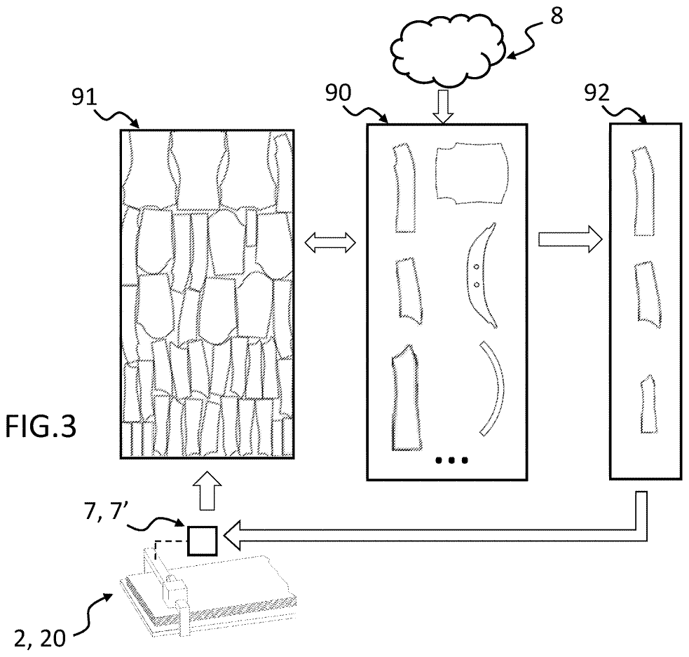

Firstly, the method exemplarily comprises providing (in a digital environment) a finite set of predetermined reference shapes 90 (FIG. 3). To this end, the memory unit 8 exemplarily contains a database of digital information representative of the finite set of reference shapes 90. Exemplarily the processing unit 7 is programmed and configured for having access to such database in order to be able to provide of the finite set of reference shapes.

Exemplarily the database of reference shapes is realized on empirical basis as a function of an outcome of a shape cutting operation. In other words, each reference shape is inserted into the database after a respective cutting operation whose result has generated corresponding defective pieces, thus creating a “black list” of shapes.

For example, the database can be realized (and possibly updated) by a third-party managing entity, where each user (i.e. a subject who operates one or more cutting machines of system 1) has access to the database but cannot modify the information contained therein (e.g. the processing unit 7 is connected in read-only mode to the memory unit 8).

This architecture is schematically shown in the embodiment of FIG. 1, ideally by the single arrow directed from the memory unit 8 to the processing unit 7 (but not vice versa). The figure exemplarily shows a single cutting machine, but the system can comprise any number of users, each with read-only access to the database.

In another embodiment, the database can be realized (and eventually updated) by each user, in addition to or as an alternative to the managing entity. Each user can therefore have access to the database for modifying the set of reference shapes (e.g. the processing unit 7 is connected to the memory unit 8 both with reading and with writing access), advantageously adding new reference shapes found during the usual cutting procedures (because they have generated corresponding defective pieces).

This architecture is for example the one shown in FIG. 2, where each processing sub-unit 7′ is connected with double arrow to the memory unit 8 (ideally the double arrow represents the aforementioned reading and writing connection).

To this end, the processing unit 7 (or each processing sub-unit 7′) can be equipped with an appropriate software that allows the operators of the machine, for example by an appropriate user interface, to access the database and upload the information related to new reference templates. Eventually, access authorization limitations can be set for avoiding that a single user can tamper with the database.

Exemplarily, the method comprises providing (in the digital environment) a set of current shapes 91 (to be cut from the sheet material), represented in FIG. 3 as an exemplar placement that must be cut by a given cutting machine 2, 20. To this end, the processing unit 7 is programmed and configured for loading into the memory unit 8 the set of current shapes in the form of respective digital information. For example, the set of current shapes can be represented (or realized starting from) a digital file containing a plurality of shapes, typically realized by a computer-assisted design software (CAD software).

Exemplarily, each user of the system 1 provides its own placement by loading its own set of current shapes into memory by the respective processing unit (or sub-unit) 7 (7′).

Exemplarily, the method therefore comprises, exemplarily by the processing unit (or sub-unit) 7, performing a respective geometric comparison between each current shape with the reference shapes. Exemplarily, the aforementioned geometric comparison allows to verify whether the set of current shapes comprises one or more reference shapes, i.e., therefore, whether among the current shapes there are shapes that are difficult to cut (exemplarily classified as difficult precisely by virtue of the fact that previous cutting operations, whose results may also have been provided by a different user, of such shapes have generated defective pieces).

For example, the aforementioned respective geometric comparison is performed by geometric similarity criteria (also valid for detecting geometric identity between the shapes). In one example, the comparison may comprise the following steps (for each current shape):
selecting among the reference shapes those having the same number of angles as the current shape;
for the current shape and each reference shape selected in the previous point, identifying the corresponding angles and the corresponding sides (e.g. sides between two corresponding angles);
verifying that corresponding angles have the same amplitude (eventually setting a tolerance of a few degrees, for example +−2°);
verifying that corresponding sides are all proportional to each other with the same proportionality ratio (possibly with an error threshold, for example +−2%).

In FIG. 3 it is exemplarily graphically shown the geometric comparison phase of the placement of a given user (i.e. a given machine 2, 20) with the finite set of reference shapes (provided by the database loaded in the memory unit 8), which returns a sub-set of current shapes 92 which comprises the current shapes that resulted identical, or similar (e.g. same profile but with different scale factor), to the reference shapes. Such current shapes of the sub-set therefore belong to the aforementioned “black list” of the shapes considered difficult, for which it is necessary to set in dedicated way one or more cutting parameters in order to perform the cut with desired quality.

Exemplarily the method therefore comprises, exemplarily the processing unit 7 is programmed and configured for, determining at least one cutting parameter for each current shape as a function of the outcome of the aforementioned respective geometric comparison (for obtaining at least one cutting parameter determined). In other terms, for each current shape of the sub-set 92, at least one cutting parameter is appropriately adjusted.

For example, the adjustment of the at least one cutting parameter can involve one or more of the following physical quantities/process functionalities: speed of horizontal movement (e.g. parallel to the cutting plane 3) of the cutting device, speed of vertical oscillation (e.g. perpendicular to the cutting plane) of the cutting device, path in a plane (e.g. parallel to the cutting plane) of the cutting device, direction of motion in the plane (e.g. parallel to the cutting plane) of the cutting device, suction force of the suction system, possibility of vertical lifting of the cutting device when at one or more vertices of the current shape, activation of cooling devices of the cutting device.

For example, in case of current shapes classified as difficult, the horizontal movement speed of the cutting device may be reduced compared to non-difficult shapes.

For example, in case of difficult shapes, it can be provided increasing the vertical oscillation speed of the cutting device.

For example, still in case of difficult shapes, the cutting device can be lifted at the vertices of the shape, to be then lowered for penetrating the sheet material on the following side of the shape (rather than modifying the respective direction of motion while maintaining at the sheet material level).

For example, still in case of difficult shapes, the suction force of the sheet material against the cutting plane can be increased by (automatically) acting on the suction system.

For example, still in case of difficult shapes, it may be provided modifying the path of the cutting device along the cutting plane by cutting the shape with a greater scale factor in order to take into account any possible shrinkage of the sheet material following the cutting.

For example, still in case of difficult shapes, it may be provided modifying the path of the cutting device along the cutting plane as a function of the distance between the current shape and further shapes of the placement adjacent to it (already cut or to be cut subsequently), for example for performing a single cutting passage when the shapes are very close.

Optionally, it can be provided determining a combination of the settings of two or more of the aforementioned cutting parameters in suitable way for the cutting of a single difficult current shape.

Furthermore, determining the at least one cutting parameter can also comprise the case in which no cutting parameter is modified compared to the cutting operation previously performed on a current shape (e.g. if the current shape previously cut is of the same type as the one to be cut, i.e. both difficult or not difficult).

Exemplarily, it is therefore provided cutting each current shape with at least one cutting parameter determined. To this end, the processing unit 7 is programmed and configured for controlling the cutting device of the cutting machine for cutting each current shape from the sheet material with (e.g. as a function of) the at least one cutting parameter determined.

In one embodiment, for example in combination with the system for cutting 1 of FIG. 2, the method can comprise that each user, whenever it needs to perform cutting operations on a respective placement, can access the memory unit 8 for consulting the database for comparing its own current shapes with the reference shapes. To this end, the method can exemplarily comprise:
providing a further set of respective current shapes to be cut from the sheet material for each further cutting machine;
performing a respective geometric comparison between each respective current shape of each further set with the reference shapes;
determining at least one respective cutting parameter for each respective current shape as a function of an outcome of the respective geometric comparison;
cutting each respective current shape from the sheet material with at the least one respective cutting parameter determined.

In this case, all the users exemplarily share the same finite set of reference shapes (i.e. a database of common reference shapes is realized).

In one embodiment the method further comprises associating to each reference shape one or more reference sheet materials (e.g. associating each shape to a specific warp-weft fabric, or non-woven fabric, or to the natural/synthetic leather, etc.). Exemplarily, the memory unit contains one or more reference sheet materials associated to each reference shape. Exemplarily, determining the at least one parameter is also performed as a function of a comparison between a current sheet material (e.g. from which the current shapes have to be cut) and one or more reference sheet materials.

1. A method for automatic cutting a sheet material, the method comprising:
providing a finite set of reference shapes;
providing a set of current shapes;
performing a comparison between each current shape with said reference shapes;
determining at least one cutting parameter for each current shape as a function of said comparison; and
cutting each current shape with said at least one cutting parameter determined.

2. The method according to claim 1, wherein providing said finite set of reference shapes is performed on an empirical basis as a function of an outcome of a set of shape cutting operations.

3. The method according to claim 1, wherein providing said finite set of reference shapes comprises realizing a database containing digital information representative of each reference shape, wherein, following a cutting operation of a determined shape, it is provided inserting said determined shape into said finite set of reference shapes on condition that said cutting operation has generated a defective cut piece, and wherein providing said finished set of reference shapes comprises updating said finished set of reference shapes subsequently to said cutting each current shape of said set, as a function of an outcome of a cutting operation of said current shapes.

4. The method according to claim 1, further comprising:
providing one or more further sets of respective current shapes;
performing a comparison between each respective current shape of said one or more further sets with said reference shapes of said finished set;
determining at least one respective cutting parameter for each respective current shape as a function of said comparison; and
cutting each respective current shape with said at least one respective cutting parameter determined.

5. The method according to claim 1, wherein performing said comparison comprises evaluating a geometric similarity between said each current shape with said reference shapes, wherein determining said at least one cutting parameter comprises adjusting a respective value of at least one of the following physical quantities and/or determining an activation of at least one of the following process functionalities: speed of horizontal movement of a cutting device, speed of vertical oscillation of the cutting device, path in a plane of the cutting device, direction of motion in the plane of the cutting device, suction force of a suction system of a cutting machine, possibility of vertical lifting of the cutting device when at one or more vertices of said current shape, active cooling of the cutting device, wherein said method comprises associating to each reference shape one or more reference textile materials, and wherein determining said at least one cutting parameter is also performed as a function of a comparison between a current textile material and said one or more reference textile materials.

6. A system for automatic cutting a sheet material comprising an automatic cutting machine of sheet material, and a processing unit having a memory unit, wherein said memory unit contains a finite set of reference shapes, and wherein said processing unit is programmed and configured for:
loading a set of current shapes;
performing a comparison between each current shape with said reference shapes of said finite set;
determining at least one cutting parameter for each current shape as a function of said comparison; and
commanding a cutting device of said cutting machine for cutting each current shape with said at least one cutting parameter determined.

7. The system according to claim 6, comprises one or more further cutting machines, and a central electronic unit comprising said memory unit, wherein said processing unit comprises a respective processing sub-unit for each machine of said system, wherein each processing sub-unit is in data communication with said central electronic unit for consulting said set of reference shapes, and wherein said processing unit is programmed and configured for:
for each further cutting machine, loading a respective further set of current shapes;
performing a comparison between each current shape of each further set with said reference shapes;
determining at least one respective cutting parameter for each current shape of each further set as a function of said comparison;
commanding a respective cutting device of each further cutting machine for cutting each current shape of the respective further set with said at least one respective cutting parameter determined.

8. The system according to claim 6, wherein said processing unit is programmed and configured for accessing and writing to said memory unit for updating said finite set of reference shapes.

9. A computer program embodied on a non-transitory computer-readable medium, which, when executed by a processing unit, executes the method according to claim 1.

10. A non-transitory computer-readable medium containing a computer program which, when executed by a processing unit, executes the method according to claim 1.
